(19) United States
(12) Patent Application Publication
(10) Pub. No.: US 2016/0326410 A1
(43) Pub. Date: Nov. 10, 2016

(54) SEALER FOR SEALING COVERED-WIRE

(71) Applicant: JSR CORPORATION, Minato-ku (JP)

(72) Inventors: Hiroshi YAMAGUCHI, Minato-ku (JP); Kazuyuki KONDOU, Minato-ku (JP); Takahiko KUROSAWA, Minato-ku (JP); Hirokazu IMAI, Minato-ku (JP); Zen KOMIYA, Minato-ku (JP)

(73) Assignee: JSR CORPORATION, Minato-ku (JP)

(21) Appl. No.: 15/104,016

(22) PCT Filed: Dec. 12, 2014
(86) PCT No.: PCT/JP2014/082989

§ 371 Date: Jun. 13, 2016

(30) Foreign Application Priority Data
Dec. 13, 2013 (JP) 2013-258281
Jul. 14, 2014 (JP) 2014-143932

(51) Int. Cl. C09J 133/08; H01B 13/00

(52) U.S. Cl. CPC C09J 133/08; H01B 13/003

(57) ABSTRACT

A wire sealer having sufficient sealing properties and satisfactory workability of sealing treatment is provided. The wire sealer is radiation-curable, and contains the following components (A) to (C):
(A) urethane (meth)acrylate;
(B) a compound having one ethylenically unsaturated group and not having an anion dissociative group; and
(C) a radiation polymerization initiator,
wherein a cured film obtained from the radiation-curable wire sealer shows an oil absorptivity of 7% by mass or more, a water absorptivity of 10% by mass or less, and a Young's modulus of 2 to 500 MPa.

### FIELD OF THE INVENTION

The present invention relates to a wire sealer, a sealing member, a sealed electrical wire, and a method for sealing treatment which are used for covered wires or cables, particularly, for example, telephone cables, inter and intra connection wires for electronic appliance, or electrical wires for automobiles.

### BACKGROUND OF THE INVENTION

For producing electrical wires, telephone cables, inter and intra connection wires for electronic appliance, or electrical wires for an automobile, copper, aluminum, or an alloy of copper or aluminum which is excellent in electric characteristics and transmission characteristics is mainly used as a conductor. A covered wire using polyvinyl chloride (PVC) or polyethylene (PE) is mainly used as a coating layer for covering a conductor. In lead wires for television set, for example, PE coating or the same covered with a rubber on its outside sheath is used. Further, for coating of electrical wires for automobiles, for example, PVC, polyethylene terephthalate (PET), or cross-linked PE is widely used. In addition, a cable in which a plurality of covered wires are bundled and a sheath (protective armor) made of an insulator is provided to its outside is also used (Patent Documents 1 to 4).

Further, for metal portion, such as a terminal fitting (also referred to as a connector) or a terminal cap, which is electrically connected to the conductors of these covered wires, copper, aluminum, an alloy of copper or aluminum, or a material obtained by performing plating treatment on these metal materials with tin, nickel, or gold (for example, brass subjected to plating treatment with tin) is used.

In an electric contact portion at which these covered wires (hereinafter, simply referred to as “wires”) or cables are electrically connected to each other or at which a covered wire and, for example, a terminal fitting (also referred to as a “connector”) are electrically connected to each other, or a contact portion between a conductor exposure portion obtained by partially removing a coating layer or a sheath as an insulator to expose the conductor and, for example, a terminal cap, the conductor is exposed. Therefore, rust may occur in the conductor due to the entering of water from outer environments, or a decrease in electrical conductivity or deterioration of the wires and the cables may occur due to corrosion of the conductor. For this reason, in many cases, the electric contact portion or the conductor exposure portion is protected by the sealing material, and thus the entering of water into the electric contact portion or the conductor exposure portion is prevented (water-proofing), thereby preventing the occurrence of rust (rust-proofing) or corrosion (corrosion-proofing). In this specification, processes to perform protection by using the sealing material for these purposes are collectively called “sealing treatment” That is, the concept of the sealing treatment is to include water-proofing treatment, rust-proofing treatment, and corrosion-proofing treatment.

Non-curing type water-absorbing resins, or thermosetting resins such as silicone grease (Patent Documents 5 to 9) ultraviolet curable resins (Patent Documents 10 to 12) are conventionally used as a material used for sealing treatment of wires or cables (hereinafter, referred to as the “wire sealer”.

### CITATION LIST

### Patent Document

Patent Document 1: JP 2001-312925 A
Patent Document 2: JP 2005-187595 A
Patent Document 3: JP 2006-348137 A
Patent Document 4: JP 2007-45952 A
Patent Document 5: JP 2008-123712 A
Patent Document 6: JP 2008-177171 A
Patent Document 7: JP 2008-078017 A
Patent Document 8: JP 09-102222 A
Patent Document 9: JP 2012-38566 A
Patent Document 10: WO 2005/071792
Patent Document 11; JP 2005-347167 A
Patent Document 12: JP 2011-256429 A

### SUMMARY OF THE INVENTION

### Problems to be Solved by the Invention

However, the wire sealer formed by the non-curing material of the related art may be easily peeled off and the sealing properties may be deteriorated. Further, the wire sealer formed by the thermosetting resin requires a long time for thermal curing, and thus a problem arises in that the working efficiency of the sealing treatment is decreased. In the wire sealer formed by the ultraviolet curable resin of the related art, a problem arises in that sealing properties of a metal portion such as a conductor of the covered wire or a terminal fitting are not sufficient.

As further describing the sealing properties, the wire sealer requires a high adhesiveness with respect to copper, aluminum, an alloy of copper or aluminum, or a material obtained by performing plating treatment on these metal materials with tin, nickel or gold, which is a metal portion constituting the conductor of the covered wire or a terminal metal. When the adhesiveness is too small, a gap is formed between the sealing member obtained by curing the wire sealer and the metal portion, and, for example, water enters into the gap, thereby decreasing the sealing properties. In general, since a technical means for securing the adhesiveness differs when a target substance to be adhered differs, it is difficult to obtain satisfactory sealing properties, for example, even when an optical fiber coating material requiring adhesiveness with glass is applied to the wire sealer.

Further, when the conductor of the covered wire and, for example, the terminal fitting are formed by different metals, corrosion phenomenon easily occurs due to, for example, a difference in ionization tendency of each metal. Therefore, even in this case, effective sealing effect is required.

Therefore, an object of the present invention is to provide a wire sealer having sufficient sealing properties and satisfactory workability of sealing treatment.

### Means for Solving the Problem

In this regard, the present inventors attempted to develop a wire sealer as an alternative to the wire sealer of the related art, focused on a urethane (meth)acrylate-based radiation-curable resin composition, and conducted various studies thereon. As a result, the inventors found that a radiation-curable wire sealer, which contains urethane (meth)acrylate, a compound having one ethylenically unsaturated group and not having an anion dissociative group, and a radiation polymerization initiator and by which a cured film having an oil absorptivity, a water absorbability, and a Young's modulus within a specific range is obtained, has sufficient sealing properties and satisfactory workability. Therefore, the present invention has been completed.

That is, according to the present invention, there is provided a radiation-curable wire sealer comprising the following components (A) to (C), wherein a cured film obtained from the radiation-curable wire sealer shows an oil absorptivity of 7% by mass or more, a water absorptivity of 10% by mass or less, and a Young's modulus of 2 to 500 MPa.

(A) urethane (meth)acrylate

(B) a compound having one ethylenically unsaturated group and not having an anion dissociative group

(C) a radiation polymerization initiator

A cured film used for measuring the oil absorptivity and the water absorptivity is obtained via the below steps:
applying the radiation-curable wire sealer onto a polyethylene terephthalate plate using an applicator bar capable of performing application to have a thickness of 200 μm, and
irradiating the radiation-curable wire sealer with an ultraviolet ray having an energy intensity of 200 mJ/cm²/s for 5 s in air.

The oil absorptivity is a value obtained via the below steps:
cutting about 1 g of the cured film for use as a film for measuring the oil absorptivity,
weighing a mass W1 (g) of the film is weighed,
immersing the film in transmission oil for automobiles,
wiping the oil adhered to the surface of the film off using a non-woven fabric,
weighing a mass W2 (g) of the film, and
calculating the oil absorptivity according to the below equation.

Oil absorptivity (% by mass)={(W2−W1)/W1}×100

The water absorptivity is a value obtained via the below steps:
cutting about 1 g of the cured film for use as a film for measuring the water absorptivity,
drying the film for 24 hours by a vacuum dryer of 50° C.,
weighing the mass W1 (g) after drying is weighed,
immersing the film in distilled water,
leaving the film to stand for 24 hours in a thermo-hygrostat (23° C. and a relative humidity of 50%),
removing the film from the thermo-hygrostat, and wiping water droplets adhered to the surface of the film off using a non-woven fabric,
weighing the mass W2 (g) of the film,
drying the film again for 24 hours by the vacuum dryer of 50° C.,
weighing a mass W3 (g) of the film, and
calculating the water absorptivity according to the below equation.

Water absorptivity (% by mass)={(W2−W3)/W1}×100

A cured film for measuring the Young's modulus is obtained via the below steps:
applying the radiation-curable wire sealer onto a glass plate using an applicator bar capable of performing application to have a thickness of 200 μm, and
irradiating the radiation-curable wire sealer with an ultraviolet ray having an energy intensity of 200 mJ/cm²/s for 5 s in nitrogen atmosphere.

The Young's modulus is a value obtained via the below steps:
preparing a strip sample having an extended portion having a width of 6 mm and a length of 25 mm, from the cured film, and
performing tensile test at a temperature of 23° C. and a humidity of 50%, and measuring a tensile strength at a tension rate of mm/min and a distortion of 2.5%.

Further, according to the present invention, there is provided a sealing member being obtained by curing the radiation-curable wire sealer according.

### Effects of the Invention

When the wire sealer that is the composition of the present invention is used, the sealing layer as a coating layer which is uniform and is excellent in strength is easily formed by irradiation of radiation such as an ultraviolet ray, and the coating layer is not formed by a thermoplastic resin but formed by the sealing member as a cured product having a crosslinking structure obtained by curing the radiation-curable resin composition. Therefore, the coating layer is not melted even at temperature at which the thermoplastic resin of the related art is melted. For this reason, compared to a conventional case where the coating layer is formed by, for example, PVC or PE, the coating layer can be used even in a high temperature environment. The wire coating layer formed by using the composition of the present invention has a high Young's modulus, and thus the coating layer is strong against an external stress and has an appropriately large breaking elongation. Accordingly, the coating layer is excellent in the adhesive force with a metal portion such as a conductor or a terminal fitting. Therefore, even when the sealed portion of the wire is partially damaged, an interface between the sealing layer and the conductor is less likely to peel off, and even when the conductor of the wire and the terminal fitting are formed by a dissimilar metal, it is possible to effectively prevent entering of water into the interface, occurrence of rust, and corrosion of the conductor.

### DETAILED DESCRIPTION OF THE INVENTION

1. Wire sealer

According to a wire sealer of the present invention, there is provided a radiation-curable wire sealer including the following components (A) to (C), wherein a cured film obtained from the radiation-curable wire sealer has an oil absorptivity of 7% by mass or more, a water absorptivity of 10% by mass or less, and a Young's modulus of 2 to 500 MPa.

(A) urethane (meth)acrylate

(B) a compound having one ethylenically unsaturated group and not having an anion dissociative group

(C) a radiation polymerization initiator

A cured film used for measuring the oil absorptivity and the water absorptivity is obtained in such a manner that the radiation-curable wire sealer is applied onto a polyethylene terephthalate plate using an applicator bar capable of performing application to have a thickness of 200 μm and the radiation-curable wire sealer is irradiated with an ultraviolet ray having an energy intensity of 200 mJ/cm²/s for 5 s in air.

The oil absorptivity is a value obtained by the following equation when about 1 g of the cured film is cut and used as a film for measuring the oil absorptivity, a mass W1 (g) of the film is weighed, the measurement film is immersed in transmission oil for automobiles, oil adhering the surface is then wiped off with a non-woven fabric, and a mass W2 (g) of the measurement film is measured,

Oil absorptivity (% by mass)={(W2−W1)/W1}×100

The water absorptivity is a value obtained by the following equation when about 1 g of the cured film is cut and used as a film for measuring the water absorptivity, the film is dried for 24 hours by a vacuum dryer of 50° C., the mass W1 (g) after drying is weighed, the measurement film is then immersed in distilled water, the film is left to stand for 24 hours in a thermo-hygrostat (23° C. and a relative humidity of 50%), the measurement film is taken out from the thermo-hygrostat, water droplets adhering the surface are wiped off with a non-woven fabric, the mass W2 (g) of the measurement film is measured, this film is dried again for 24 hours by the vacuum dryer of 50° C., a mass W3 (g) of the measurement film is measured,

Water absorptivity (% by mass)={(W2−W3)/W1}×100

A cured film for measuring the Young's modulus is obtained in such a manner that the radiation-curable wire sealer is applied onto a glass plate using an applicator bar capable of performing application to have a thickness of 200 μm and the radiation-curable wire sealer is irradiated with an ultraviolet ray having an energy intensity of 200 mJ/cm²/s for 5 s in nitrogen.

The Young's modulus is a value obtained from a tensile strength at a tension rate of 1 mm/min and a distortion of 2.5% when a strip sample is prepared from the cured film so as to have an extended portion having a width of 6 mm and a length of 25 mm, and a tensile test is performed at a temperature of 23° C. and a humidity of 50%.

The wire sealer of the present invention is a material to be used for sealing treatment of a wire or a cable.

When the wire sealer of the present invention is cured, it is possible to obtain a cured membrane (sealing member) having a low water absorbability, a high oil absorbability, and a satisfactory Young's modulus as the wire sealer. Since the cured membrane obtained from the wire sealer of the present invention has a low water absorbability, an effect of preventing water from entering is large, and thus a conductive wire or a connector can be protected from rust. Further, since the oil absorbability is high, even in a case where foreign substances such as an oil component and dust containing an oil component are adhered to a portion to be sealed, the adhered oil component is effectively absorbed. Therefore, adhesiveness with respect to a conductive wire or a connector can be maintained high, and even in a workplace where environment is not clean all the time, an effective sealing effect can be exerted. Further, since the cured membrane has a satisfactory Young's modulus as the wire sealer, there is no case where, since the Young's modulus is too low, a sealing layer is easily broken due to an external stress. Therefore, a strong sealing layer can be obtained. In addition, there are few cases where, since the Young's modulus is too high, a sealing layer becomes fragile, and thus cracks occur due to an external stress so that the sealing layer is broken. Therefore, a strong sealing layer can be obtained.

A cured film obtained by curing the wire sealer of the Present invention has a water absorptivity of 10% by mass or less. When the water absorptivity is 10% by mass or less, an effect of preventing water from entering is large, and thus a conductive wire or a connector can be protected from rust. Herein, the water absorptivity is measured by the following method.

### Method for Producing Cured Film for Measuring Water Absorptivity:

A cured film as a cured membrane is obtained in such a manner that a radiation-curable wire sealer is applied onto a polyethylene terephthalate plate using an applicator bar capable of performing application to have a thickness of 200 μm and the radiation-curable wire sealer is cured by irradiation of an ultraviolet ray having an energy intensity of 200 mJ/cm²/s for 5 s in air.

### Method for Measuring Water Absorptivity:

About 1 g of the cured film is cut and used as a film for measuring the water absorptivity. The measurement film is dried for 24 hours by a vacuum dryer of 50° C., a mass W1 (g) after drying is weighed. The dried film is immersed in distilled water and left to stand for 24 hours in a thermo-hygrostat (23° C. and a relative humidity of 50%), the measurement film is taken out from the thermo-hygrostat, water droplets adhering the surface are wiped off with a non-woven fabric, and a mass W2 (g) of the measurement film is measured. This film is dried again for 24 hours by the vacuum dryer of 50° C., a mass W3 (g) of the measurement film is measured. The water absorptivity is calculated by the following equation.

Water absorptivity (% by mass)={(W2−W3)/W1}×100

The cured film obtained by curing the wire sealer of the present invention has an oil absorptivity of 7% by mass or more, and preferably an oil absorptivity of 10% by mass or more. When the oil absorptivity is 7% by mass or more, even in a case where foreign substances such as an oil component and dust containing an oil component are adhered to a portion to be sealed, the adhered oil component is effectively absorbed. Therefore, adhesiveness with respect to a conductive wire or a connector can be maintained high, and even in a workplace where environment is not clean all the time, an effective sealing effect can be exerted.

Herein, the oil absorptivity is measured by the following method.

A cured film for measuring the oil absorptivity is obtained in the same manner as in the method for producing the cured film for measuring the water absorptivity.

### Method for Measuring Oil Absorptivity:

About 1 g of the cured film is cut and used as a film for measuring the oil absorptivity, and the mass W1 (g) thereof is weighed. This measurement film is immersed in transmission oil for automobiles (TOTAL transmission FR 75W90; manufactured by Total S.A.), oil adhering the surface is then wiped off with a non-woven fabric, and the mass W2 (g) of the measurement film is measured. The oil absorptivity is calculated by the following equation.

Oil absorptivity (% by mass)={(W2−W1)/W1}×100

The cured film obtained by curing the wire sealer of the present invention has a Young's modulus at normal temperature (23° C.) of 2 to 500 MPa, and the Young's modulus is preferably 10 to 200 MPa and more preferably 10 to 100 MPa.

When the Young's modulus is values in the above range, the cured film is suitable as the wire sealer, and there is no case where, since the Young's modulus is too low, a sealing layer is easily broken due to an external stress. Therefore, a strong sealing layer can be obtained. In addition, there are few cases where, since the Young's modulus is too high, a sealing layer becomes fragile, and thus cracks occur due to an external stress so that the sealing layer is broken. Therefore, a strong sealing layer can be obtained.

Herein, the Young's modulus is measured by the following method.

### Method for Producing Cured Film for Measuring Young's Modulus:

A cured film for measuring the Young's modulus is obtained in such a manner that a radiation-curable wire sealer is applied onto a glass plate using an applicator bar capable of performing application to have a thickness of 200 μm and the radiation-curable wire sealer is cured by irradiation of an ultraviolet ray having an energy intensity of 200 mJ/cm²/s for 5 s in nitrogen.

### Method for Measuring Young's Modulus:

The Young's modulus is obtained from a tensile strength at a tension rate of 1 mm/min and a distortion of 2.5% when a strip sample is prepared from the cured film so as to have an extended portion having a width of 6 mm and a length of 25 mm, and a tensile test is performed at a temperature of 23° C. and a humidity of 50%.

Further, the cured film obtained by curing the wire sealer of the present invention preferably has a breaking strength at normal temperature (23° C.) of 0.5 to 40 MPa, and the breaking strength is more preferably 1 to 30 MPa. The breaking elongation is preferably 50 to 500% and more preferably 100 to 400%. Regarding the breaking strength at low temperature (−40° C.), the breaking elongation is preferably 50 to 400% and more preferably 50 to 300%. When the Young's modulus is values in the above range, the cured film is suitable as the wire sealer. There is no case where, since the Young's modulus is too low, a sealing layer is easily broken due to an external stress. Therefore, a strong sealing layer can be obtained. In addition, there are few cases where, since the Young's modulus is too high, a sealing layer becomes fragile, and thus cracks occur due to an external stress so that the sealing layer is broken. Therefore, a strong sealing layer can be obtained.

Urethane (meth)acrylate serving as the component (A) is not particularly limited as long as it is a compound having a urethane bond and one or more (meth)acryloyl groups, and urethane (meth)acrylate having one or two (meth)acryloyl groups and a structural unit derived from one or two or more dials selected from the group consisting of a polyether diol, a polyester diol or a polycarbonate diol and having an aliphatic structure is preferable.

Among these urethane (meth)acrylates, urethane (meth)acrylate (a component (A1)) having one (meth)acryloyl group and a structural unit derived from one or two or more dials selected from the group consisting of a polyether diol, a polyester diol or a polycarbonate dial and having an aliphatic structure is produced by reaction of diisocyanate, hydroxyl group-containing (meth)acrylate, and monoalcohol (primary alcohol), and one or two or more dials selected from the group consisting of a polyether diol, a polyester diol or a polycarbonate diol and having an aliphatic structure. That is, the component (A1) is produced by reacting an isocyanate group of diisocyanate with a hydroxyl group of diol, a hydroxyl group of hydroxyl group-containing (meth)acrylate, and a hydroxyl group of monoalcohol, respectively.

Examples of the reaction method include a method of collectively inputting diol, diisocyanate, hydroxyl group-containing (meth)acrylate, and monoalcohol and performing reaction thereon; a method of reacting a diol with diisocyanate, followed by reaction with monoalcohol, and then performing reaction with hydroxyl group-containing (meth)acrylate; a method of reacting diisocyanate with hydroxyl group-containing (meth)acrylate, followed by reaction with diol, and then performing reaction with monoalcohol; and a method of reacting diisocyanate, hydroxyl group-containing (meth)acrylate, monoalcohol with one another, followed by reaction with dial, and finally performing reaction with hydroxyl group-containing (meth)acrylate. Among these methods, in order to synthesize urethane (meth)acrylate having two or more structural units derived from a diol, a method of reacting a diol with diisocyanate, followed by reaction with monoalcohol, and then performing reaction with hydroxyl group-containing (meth)acrylate is preferable.

Urethane (meth)acrylate (a component (A2)) having two (meth)acryloyl groups and a structural unit derived from one or two or more diols selected from the group consisting of a polyether diol, a polyester diol or a polycarbonate diol and having an aliphatic structure is produced by reaction of diisocyanate, hydroxyl group-containing (meth)acrylate, and one or two or more diols selected from the group consisting of a polyether diol, a polyester dial or a polycarbonate diol and having an aliphatic structure. That is, the component (A2) is produced by reacting an isocyanate group of diisocyanate with a hydroxyl group of dial and a hydroxyl group of hydroxyl group-containing (meth)acrylate, respectively.

Examples of the reaction method include a method of collectively inputting dial, diisocyanate, and hydroxyl group-containing (meth)acrylate and performing reaction thereon; a method of reacting a dial with diisocyanate, and then performing reaction with hydroxyl group-containing (meth)acrylate; a method of reacting diisocyanate with hydroxyl group-containing (meth)acrylate, and then performing reaction with dial; and a method of reacting diisocyanate with hydroxyl group-containing (meth)acrylate, followed by reaction with diol, and finally performing reaction with hydroxyl group-containing (meth)acrylate. Among these methods, in order to synthesize urethane (meth)acrylate having two or more structural units derived from a dial, a method of reacting a dial with diisocyanate, and then performing reaction with hydroxyl group-containing (meth)acrylate is preferable.

As the dial, it is preferable to use one or two or more diols selected from the group consisting of a polyether dial, a polyester dial or a polycarbonate dial and having an aliphatic structure. When dial has the aliphatic structure, it is possible to obtain a wire sealer having a flexible structure and satisfactory adhesiveness with a metal portion such as a conductor or a terminal fitting. Incidentally, the dial, which is a polyether diol, a polyester diol or a polycarbonate diol and has an aliphatic structure, means a polyether diol, a polyester diol, and a polycarbonate diol each having an aliphatic structure, and the diol may have a cyclic structure in addition to the aliphatic structure. For example, a diol having a structure, which has a repeating unit of an alkylene oxide structure at both ends of a bisphenol A structure, is also included.

Examples of the polyether diol having an aliphatic structure include diols obtained by ring-opening polymerization of ion polymerizable cyclic compounds such as ethylene oxide, propylene oxide, butene-1-oxide, isobutene oxide, tetrahydrofuran, 2-methyltetrahydrofuran, and 3-methyltetrahydrofuran. At this time, a copolymer composed of two or more types of ion polymerizable cyclic compounds may be used, and in this case, the type of polymerization of each structural unit in the diol is not particularly limited, and may be any one of random polymerization, block polymerization, cross polymerization, and graft polymerization.

Examples of an aliphatic polyether diol obtained by ring-opening polymerization of one type of the ion polymerizable cyclic compounds described above may include diols such as polyethylene glycol, polypropylene glycol (PPG), polytetramethylene glycol (PTMG), polyhexamethylene glycol, polyheptamethylene glycol, and polydecamethylene glycol. Further, specific examples of the polyether diol obtained by ring-opening copolymerization of two or more types of ion polymerizable cyclic compounds described above may include binary copolymers obtained by a combination such as tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, or butene-1-oxide and ethylene oxide; and ternary copolymers obtained by a combination of tetrahydrofuran, butene-1-oxide, and ethylene oxide. These polyether diols can be used alone or in combination of two or more kinds thereof.

The polyether diol having an aliphatic structure is commercially available as, for example, PTMG650, PTMG1000, and PTMG2000 (all manufactured by Mitsubishi Chemical Corporation), PPG400, PPG1000, EXCENOL720, 1020, and 2020 (all manufactured by Asahi-Olin Ltd.), PEG1000, UNISAFE DC1100, and DC1800 (all manufactured by NOF CORPORATION), PPTG2000, PPTG1000, PTG400, and PTGL2000 (all manufactured by Hodogaya Chemical Co., Ltd.), and Z-3001-4, Z-3001-5, PBG2000A, PBG2000B, EO/B04000, and EO/B02000 (all manufactured by DKS Co. Ltd.).

Among the polyether diol compounds having an aliphatic structure, a polyether diol having a polyether structure obtained by ring-opening polymerization of tetrahydrofuran or propylene oxide is particularly preferable. Specific examples thereof include polytetramethylene glycol, polypropylene glycol, polypropylene triol, polypropylene hexaol, and a binary copolymer of propylene oxide and tetrahydrofuran, propylene oxide and ethylene oxide, or propylene oxide and butylene oxide.

Examples of the polyester dial having an aliphatic structure include a polyester diol obtained by reaction of dihydric alcohol with dibasic acid. Examples of the dihydric alcohol include ethylene glycol, polyethylene glycol, propylene glycol, polypropylene glycol, tetramethylene glycol, polytetramethylene glycol, 1,6-hexanediol, neopentyl glycol, 1,4-cyclohexane dimethanol, 3-methyl-1,5-pentane diol, 1,9-nonane diol, and 2-methyl-1,8-octane dial. Examples of the dibasic acid include aromatic dicarboxylic acid such as phthalic acid, isophthalic acid, or terephthalic acid, and aliphatic dicarboxylic acid such as maleic acid, fumaric acid, adipic acid, or sebasic acid. Herein, the aliphatic dicarboxylic acid is preferably alkane dicarboxylic acid. The number of carbon atoms of the alkane moiety is preferably 2 to 20 and particularly preferably 2 to 14. Further, the aromatic moiety of the aromatic dicarboxylic acid is preferably a phenyl group. These polyester dials can be used alone or in combination of two or more kinds thereof.

Examples of commercial products of the polyester dial having an aliphatic structure include KURARAY DIOL P-2010, P-2020, P-2030, P-2050, PMIPA, PKA-A, PKA-A2, and PNA-2000 (all manufactured by Kuraray Co., Ltd.), and KYOWAPOL 2000PA and 20003A (both manufactured by Kyowa Hakko Kogyo Co., Ltd.).

Regarding the polycarbonate dial having an aliphatic structure, in the following Formula (1), as R, one having 1 to 12 carbon atoms is preferable, and examples thereof include a divalent aliphatic hydrocarbon group such as —(CH₂)ₘ—, CH₂CH(CH₃)CH₂—, —CH₂CH₂C(CH₃)HCH₂CH₂—, or —CH₂C(CH₃)H(CH₂)₆—, and a hydrocarbon group having a divalent alicyclic structure represented by, for example, the following Formula (a). Here, m is 3 to 12 and preferably 5 to 9.

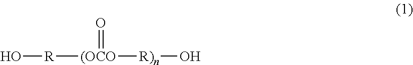

[In Formula (1), each R independently represents a divalent group having an aliphatic structure, and n is a number decided such that the number average molecular weight of the compound of Formula (1) becomes 500 to 10,000.]

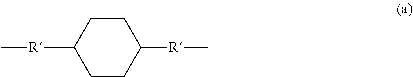

[In Formula (a), R′ represents a single bond or an alkanediyl group having I to 3 carbon atoms.]

Examples of the alkanediyl group as R′ in the above Formula include —CH₂—, —(CH₂)₂—, —(CH₂)₃—, and —CH₂—CH(CH₃)—.

Preferred specific examples of R include —(CH₂)₆—, —(CH₂)₅—, and —CH₂C(CH₃)H(CH₂)₆—. Two or more Rs may be included in a molecule of the compound represented by Formula (1).

Examples of commercial products of the polycarbonate diol represented by the above Formula (1) include:

DURANOL T6002 (a compound in which, in Formula (1), R represents —(CH₂)₆— and the number average molecular weight is 2000),

TS650E (a compound in which, in Formula (1), regrading R, the molar ratio of —(CH₂)₅— to —(CH₂)₆— is 1:1, and the number average molecular weight is 500),

T5652 (a compound in which, in Formula (1), regrading R, the molar ratio of —(CH₂)₅— to —(CH₂)₆— is 1:1, and the number average molecular weight is 2000), and

G3452 (a compound in which, in Formula (1), regrading R, the molar ratio of —(CH₂)₃— to —CH₂CH(CH₃)CH₂— is 1:1, and the number average molecular weight is 2000),

(all manufactured by Asahi Kasei Chemicals Corp.);

UH-200 (a compound in which, in Formula (1), R represents —(CH₂)₆— and the number average molecular weight is 2000),

UH-300 (a compound in which, in Formula (1), R represents —(CH₂)₆— and the number average molecular weight is 3000),

UHC50-200 (a compound in which, in Formula (1), regrading R, the molar ratio of —(CH₂)₆— to —((CH₂)₅CO₂)ₘ(CH₂)₆— is 1:1 and the number average molecular weight is 2000),

UHC50-100 (a compound in which, in Formula (1), regrading R, the molar ratio of —(CH₂)₆— to —((CH₂)₅CO₂)ₘ(CH₂)₆— is 1:1 and the number average molecular weight is 1000), and

UC-100 (a compound in which, in Formula (1), regrading R, R′ in Formula (a) represents —CH₂— and the number average molecular weight is 1000),

(all manufactured by Ube Industries, Ltd.); and

KURARAY POLYOL C-1065N (a compound in which, in Formula (1), regarding R, the molar ratio of —(CH₂)₉— to —CH₂C(CH₂)H(CH₂)₆— is 65:35 and the number average molecular weight is 1000),

C-2065N (a compound in which, in Formula (1), regarding R, the molar ratio of —(CH₂)₉— to —CH₂C(CH₃)H(CH₂)₆— is 65:35 and the number average molecular weight is 2000),

C-2015N (a compound in which, in Formula (1), regarding R, the molar ratio of —(CH₂)₉— to —CH₂C(CH₃)H(CH₂)₆— is 15:85 and the number average molecular weight is 2000),

C-2090 (a compound in which, in Formula (1), regarding R, the molar ratio of —CH₂CH₂C(CH₃)HCH₂CH₂— to —(CH₂)₆— is 9:1 and the number average molecular weight is 2000), and

C-2050 (a compound in which, in Formula (1), regarding R, the molar ratio of —CH₂CH₂C(CH₃)HCH₂CH₂— to —(CH₂)₆— is 1:1 and the number average molecular weight is 2000) (all manufactured by Kuraray Co., Ltd.).

The number average molecular weight of the diol is preferably 400 to 3000, more preferably 1000 to 3000, and particularly preferably 1500 to 2500. The number average molecular weight is a number average molecular weight in terms of polystyrene measured by a gel permeation chromatography method (GPC method). Specifically, the number average molecular weight is a number average molecular weight in terms of polystyrene obtained by performing measurement using a composite column connected to an HPLC system (HLC-8220GPC manufactured by Tosoh Corporation) in the following order and using tetrahydrofuran (THF) as a developing solvent under the condition including a flow rate of 1 ml/min.

TSKgel G4000H XL, TSKgel G3000H XL, TSKgel G2000H XL, TSKgel G2000H XL, TSKgel G4000H XL, TSKgel G3000H XL

Examples of the diisocyanate include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenyl methane diisocyanate, 4,4′-diphenyl methane diisocyanate, 3,3′-dimethyl phenylene diisocyanate, 4,4′-biphenylene diisocyanate, 1,6-hexane diisocyanate, isophorone diisocyanate, methylene bis(4-cyclohexyl isocyanate), 2,2,4-trimethyl hexamethylene diisocyanate, bis(2-isocyanate ethyl)fumarate, 6-isopropyl-1,3-phenyl diisocyanate, 4-diphenyl propane diisocyanate, lysine diisocyanate, hydrogenated diphenyl methane diisocyanate, hydrogenated xylylene diisocyanate, tetramethyl xylylene diisocyanate, and 2,5 (or 2,6)-bis(isocyanate methyl)-bicyclo[2.2.1]heptane. In particular, for example, 2,4-tolylene diisocyanate, isophorone diisocyanate, xylylene diisocyanate, or methylene bis(4-cyclohexyl isocyanate) is preferable. These diisocyanates can be used alone or in combination of two or more kinds thereof.

Examples of the hydroxyl group-containing (meth)acrylate include 2-hydroxyethyl (meth) acrylate, 2-hydroxypropyl (meth) acrylate, 2-hydroxybutyl (meth) acrylate, 2-hydroxy-3-phenyloxypropyl (meth)acrylate, 1,4-butanediol mono(meth)acrylate, 2-hydroxyalkyl (meth)acryloyl phosphate, 4-hydroxycyclohexyl (meth) acrylate, 1,6-hexanediol mono(meth)acrylate, neopentyl glycol mono(meth)acrylate, trimethylol propane di(meth)acrylate, trimethylol ethane di(meth)acrylate, pentaerythritol tri(meth)acrylate, and dipentaerythritol penta(meth)acrylate. These hydroxyl group-containing (meth)acrylates can be used alone or in combination of two or more kinds thereof.

Further, a compound obtained by addition reaction of a glycidyl group-containing compound, such as alkyl glycidyl ether, allyl glycidyl ether, or glycidyl (meth)acrylate, with (meth)acrylic acid can also be used. Among these hydroxyl group-containing (meth)acrylates, particularly, for example, 2-hydroxyethyl (meth)acrylate, or 2-hydroxypropyl (meth)acrylate is preferable.

These hydroxyl group-containing (meth)acrylate compounds can be used alone or in combination of two or more kinds thereof.

The monoalcohol is not particularly limited as long as it is a compound having one hydroxyl group, and monoalcohol having an aliphatic hydrocarbon structure is preferable, monoalcohol having an aliphatic hydrocarbon structure with 1 to 8 carbon atoms is more preferable, and monoalcohol having an aliphatic hydrocarbon structure with 1 to 4 carbon atoms is particularly preferable. When one molecular end of the (A) urethane (meth)acrylate is sealed with monoalcohol, the (A) urethane (meth)acrylate takes a structure having one (meth)acryloyl group and adhesiveness with a metal portion such as a conductor or a terminal fitting is improved. In a case where adhesiveness with respect to glass is evaluated instead of a metal member, the effect in this case is different from the effect as described above in that, when one molecular end of urethane (meth)acrylate is sealed with monoalcohol, adhesiveness tends to decrease. In the use application requiring the control of adhesiveness with a glass member such as an optical fiber coating material, there is known a technique that is intended to suppress excessive adhesiveness with respect to glass such that an optical fiber coating material is easily peeled off from a glass fiber. However, the present invention is devised as a technique of increasing adhesiveness with respect to a metal member.

Regarding the use ratio of the polyether (or -ester) diol, the diisocyanate, and the hydroxyl group-containing (meth)acrylate, with respect to 1 equivalent of the hydroxyl group contained in the polyester diol, the isocyanate group contained in the diisocyanate is preferably set to 1.1 to 3 equivalent, the monoalcohol is preferably set to 0.1 to 0.75 equivalent, and the hydroxyl group of the hydroxyl group-containing (meth)acrylate is preferably set to 0.1 to 0.75 equivalent.

In the reaction of these compounds, it is preferable to use 0.01 to 1 part by mass of a urethane forming catalyst such as copper naphthenate, cobalt naphthenate, zinc naphthenate, dilaurate dibutyl tin, triethylamine, 1,4-diazabicyclo [2.2.2] octane, or 2,6,7-trimethyl-1,4-diazabicyclo [2.2.2] octane with respect to 100 parts by mass of the total amount of a reaction product. Further, the reaction temperature is generally 10 to 90° C. and particularly preferably 30 to 80° C.

The number average molecular weight of the urethane (meth)acrylate serving as the component is preferably 8000 to 20000. The number average molecular weight of the urethane (meth)acrylate is measured by the aforementioned GPC method.

The urethane (meth)acrylate serving as the component (A) preferably has two to six structural units derived from a dial and more preferably has three to five structural units. When the structural unit derived from a dial is set to be within the above range, adhesiveness with a metal portion such as a conductor or a terminal fitting is improved.

The urethane (meth)acrylate serving as the component (A) is blended preferably in 5 to 60% by mass, more preferably in 15 to 50% by mass, and particularly preferably in 20 to 45% by mass with respect to 100% by mass of the total amount of the wire sealer, from the viewpoint of the relation between a viscosity of the composition and mechanical characteristics of a cured product. When the blended amount of the component (A) is set to be within the above rane, the viscosity of the composition is suppressed to be low. Therefore, the wire sealer easily enters, by capillary phenomenon, into a gap between a conductor and a coating layer thereof or a gap between a conductor and a terminal fitting so that effective sealing treatment can be performed. In addition, the strength of the sealing member is improved, and thus adhesiveness with a metal portion such as a conductor or a terminal fitting is improved.

In the wire sealer of the present invention, urethane (meth)acrylate other than the component (A) can also be blended within the range not impairing the effect of the present invention. The urethane (meth)acrylate other than the component (A) is not particularly limited as long as it is urethane (meth)acrylate not corresponding to the component (A), and examples thereof include urethane (meth)acrylate having a structure derived from a diol having an aromatic structure or an alicyclic structure, and urethane (meth)acrylate which does not contain a diol and is produced by reaction of diisocyanate with hydroxyl group containing (meth) acrylate.

The compound having one ethylenically unsaturated group and not having an anion dissociative group serving as the component (B) is a radical polymerizable monofunctional compound not having an anion dissociative group. Herein, the anion dissociative group is a functional group which can be dissociated from anion, and examples thereof include a phosphoric acid group, a carboxyl group (a carboxy group), and a carbonyl group (including a carbonyl group included in a urethane bond). When this compound is used as the component (B), an excessive increase in the Young's modulus of the cured product is prevented, and effective sealing treatment can be performed.

Specific examples of the component (B) include vinyl group-containing lactam such as N-vinyl pyrrolidone or N-vinyl caprolactam, alicyclic structure-containing (meth)acrylate such as isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, or 4-butyl cyclohexyl (meth) acrylate, aromatic structure-containing (meth)acrylate such as benzyl (meth)acrylate, and heterocyclic structure-containing (meth)acrylate such as (meth)acryloyl morpholine, vinyl imidazole, or vinyl pyridine. Herein, the alicyclic structure-containing (meth) acrylate, the aromatic structure-containing (meth) acrylate, and the heterocyclic structure-containing (meth)acrylate are collectively referred to as (meth)acrylate having a cyclic structure (a compound having a cyclic structure and one ethylenically unsaturated group).

Moreover, examples of the component (B) may include hydroxyl group-containing (meth)acrylate (a compound having a hydroxyl group and one ethylenically unsaturated group) such as 2-hydroxyethyl (meth)acrylate, 2-hydroxypropyl (meth)acrylate, or 4-hydroxybutyl (meth)acrylate, a compound, which has an aliphatic hydrocarbon structure with 3 to 10 carbon atoms and one ethylenically unsaturated group, such as isopropyl (meth)acrylate, isooctyl (meth)acrylate, isodecyl (meth)acrylate, sec-butyl (meth)acrylate, tert-butyl (meth)acrylate, or tert-pentyl (meth)acrylate, other aliphatic (meth)acrylate such as methyl (meth)acrylate, ethyl (meth)acrylate, propyl (meth)acrylate, octyl (meth)acrylate, nonyl (meth)acrylate, decyl (meth)acrylate, undecyl (meth)acrylate, dodecyl (meth)acrylate, lauryl (meth)acrylate, stearyl (meth)acrylate, and isostearyl (meth) acrylate, tetrahydrofurfuryl (meth) acrylate, polyethylene glycol mono(meth)acrylate, polypropylene glycol mono(meth)acrylate, methoxy ethylene glycol (meth)acrylate, ethoxy ethyl (meth)acrylate, methoxy polyethylene glycol (meth)acrylate, methoxy polypropylene glycol (meth)acrylate, polyoxyethylene nonyl phenyl ether acrylate, diacetone (meth)acrylamide, isobutoxymethyl (meth)acrylamide, N,N-dimethyl (meth)acrylamide, t-octyl (meth)acrylamide, dimethyl aminoethyl (meth)acrylate, diethylaminoethyl (meth) acrylate, 7-amino-3,7-dimethyloctyl (meth) acrylate, N,N-diethyl (meth)acrylamide, N,N-dimethylaminopropyl (meth)acrylamide, hydroxybutyl vinyl ether, lauryl vinyl ether, cetyl vinyl ether, and 2-ethylhexyl vinyl ether. These may be used alone or in combination of two or more kinds thereof.

Examples of commercial products of the component (B) include ARONICS M111, M113, M114, and M117 (all manufactured by TOAGOSEI CO., LTD.); KAYARAD, TC110S, R629, and R644 (all manufactured by Nippon Kayaku Co., Ltd.); and IBXA and Biscoat 3700 (manufactured by Osaka Organic Chemical Industry Ltd.).

Among these components (B), a compound having a cyclic structure and one ethylenically unsaturated group, a compound having one ethylenically unsaturated group and an aliphatic hydrocarbon structure with 3 to 10 carbon atoms having a branched structure, or a compound having a hydroxyl group and one ethylenically unsaturated group is preferably from the viewpoint of improving the strength of the sealing member,

The (B) compound having one ethylenically unsaturated group is blended preferably in 30 to 90% by mass, more preferably in 40 to 80% by mass, and particularly preferably in 45 to 75% by mass with respect to 100% by mass of the total amount of the wire sealer. Further, 50 to 100% by mass of the total amount of the component (B) is preferably consisted of a compound having a cyclic structure and one ethylenically unsaturated group or a compound having one ethylenically unsaturated group an aliphatic hydrocarbon structure with 4 to 10 carbon atoms having a branched structure.

A radiation polymerization initiator serving as the component (C) is not particularly limited as long as it is a compound absorbing radiation and initiating radical polymerization, and specific examples thereof include 1-hydroxy cyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophene, 4-chlorobenzophenone, 4,4′-dimethoxy benzophenone, 4,4′-diaminobenzophenone, Michler's ketone, benzo isopropyl ether, benzoin ethyl ether, benzyl dimethyl ketal, 1-(4-isopropyl phenyl)-2-hydroxy-2-methyl propane-1-on, 2-hydroxy-2-methyl-1-phenyl propane-1-on, thioxanthone, diethyl thioxanthone, 2-isopropyl thioxanthone, 2-chlorothioxathone, 2-methyl-1-[4-(methyl thio)phenyl]-2-morpholino-propane-1-on, 2,4,6-trimethyl benzoyl diphenyl phosphine oxide, and bis-(2,6-dimethoxybenzoyl)-2,4,4-trimethyl pentyl phosphine oxide. These may be used alone or in combination of two or more kinds thereof.

Examples of commercial products of the (C) radiation polymerization initiator include IRGACURE184, 369, 651, 500, 907, CGI1700, CGI1750, CGI1850, and CG24-61; Darocure 1116 and 1173 (both manufactured by Ciba Specialty Chemicals Inc.); Lucirin TPO (manufactured by BASF); and Ubecril P36 (manufactured by UCB). Further, examples of a photosensitizer include triethylamine, diethylamine, N-methyl diethanolamine, ethanolamine, 4-dimethyl aminobenzoate, 4-dimethyl amino methyl benzoate, 4-dimethyl amino ethyl benzoate, and 4-dimethyl amino isoamyl benzoate; and Ubecril P102, 103, 104, and 105 (all manufactured by UCB).

The (C) radiation polymerization initiator is blended preferably in 0.01 to 10% by mass, more preferably in 0.1 to 7% by mass, and particularly preferably in 0.3 to 5% by mass with respect to 100% by mass of the total amount of the wire sealer.

When the components (A), (B), and (C) are blended in the above ranges of the blended amount, it is possible to obtain a radiation-curable wire sealer having the aforementioned characteristics of the water absorptivity, the oil absorptivity, and the Young's modulus.

As an arbitrary component, a compound (F), which is a compound having two or more ethylenically unsaturated groups other than the compound (A), can also be contained. Such a compound is a polymerizable multifunctional compound other than urethane (meth)acrylate. However, if a large amount of the component (F) is blended, the Young's modulus of the cured product may be excessively increased, and effective sealing treatment may be difficult to perform. For this reason, the blended amount of the component (F) is set to preferably 0 to 10% by mass and more preferably 0 to 5% by mass with respect to 100% by mass of the total amount of the composition. In particular, it is preferable not to blend the component (F) at all.

The component (F) is not particularly limited, and examples thereof include trimethylol propane tri(meth)acrylate, trimethylol propane trioxyethyl (meth) acrylate, pentaerythritol tri(meth)acrylate, triethylene glycol diacrylate, tetraethylene glycol di(meth)acrylate, tricyclodecane dimethylol diacrylate (also referred to as bis((meth)acryloyloxy methyl)tricyclo[5.2.1.0^{2,6}]decane), 1,4-butanediol di(meth)acrylate, 1,6-hexanediol di(meth)acrylate, neopentyl glycol di(meth)acrylate, tripropylene glycol di(meth)acrylate, neopentyl glycol di(meth)acrylate, bisphenol A diglycidyl ether having (meth)acrylic acid added to both terminals thereof, pentaerythritol t meth)acrylate, pentaerythritol tetra(meth)acrylate, polyester di(meth)acrylate, tris(2-hydroxyethyl) isocyanurate tri(meth)acrylate, tris(2-hydroxyethyl) isocyanurate di(meth)acrylate, tricyclodecane dimethylol diacrylate, di(meth)acrylate of diol of adduct of ethylene oxide or propylene oxide of bisphenol A, di(meth)acrylate of diol of adduct of ethylene oxide or propylene oxide of hydrogenated bisphenol A, epoxy (meth)acrylate having (meth)acrylate added to diglycidyl ether of bisphenol A, and triethylene glycol divinyl ether. These may be used alone or in combination of two or more kinds thereof.

In the wire sealer of the present invention, as necessary, within the range not impairing the feature of the present invention, it is possible to blend various additives such as an antioxidant (G), a (meth)acrylate compound (H) having an anion dissociative group, a coloring agent, an ultraviolet absorber, a photo stabilizer, a silane coupling agent, a thermal polymerization inhibitor, a leveling agent, a surfactant, a storage stabilizer, a plasticizer, a lubricant, a solvent, a filler, an anti-aging agent, a wetting improver, and a coat surface improver.

Examples of the (G) antioxidant may include an antioxidant used to prevent the oxidation of the composition that is the invention of the present application (hereinafter, referred to as the component (G-1)) and an antioxidant used to prevent the oxidation of the conductor of the covered wire (hereinafter, ferred to as the component (G-2)). The component (G-1) is not particularly limited, and a well-known antioxidant can be used. Specific examples of the component include IRGANOX 1010, 1035, 1076, and 1222 (all manufactured by Ciba Specialty Chemicals Inc.) and ANTIGENE P, 3C, Sumilizer GA-80, and GP (manufactured by Sumitomo Chemical Company, Limited). These components (G-1) may be used alone or in combination of two or more kinds thereof.

The antioxidant serving as the component (G-2) is not particularly limited, and a well-known antioxidant can be used as a so-called antirust agent or rust inhibitor. Examples of the component (G-2) may include an amine-based antioxidant and a sulfur-based antioxidant.

Specific examples of the amine-based antioxidant serving as the component (G-2) may include a benzotriazole-based antioxidant such as 1,2,3-benzotriazole, 1-[N,N-bis(2-ethylhexyl)aminomethyl]benzotriazole, carboxybenzotriazole, or 1-[N,N-bi (2-ethylhexyl)aminomethyl]methylbenzotriazole (as commercial products, for example, BT-120, BT-LX, CBT-1, and TT-LX (all manufactured by Johoku Chemical Co., Ltd.), CUREZOL PZ (manufactured by SHIKOKU CHEMICALS CORPORATION), and triethanolamine (manufactured by Tokyo Chemical Industry Co., Ltd.)).

Specific examples of the sulfur-based antioxidant serving as the component (G-2) may include 2-dibutylamino-4,6-dimercapto-s-triazine, 2,4,6-trimercapto-s-triazine, 2-mercaptobenzimidazole, and 2-mercaptobenzothiazole (as commercial products, for example, Zisnet DB and Zisnet F (both manufactured by Johoku Chemical Co., Ltd.), and Nocrac MB (manufactured by OUCHI SHINKO CHEMICAL INDUSTRIAL CO., LTD)).

Specific examples of another antioxidant serving as the component (G-2) may include N,N′-bis[2-[2-(3,5-di-tert-butyl-4-hydroxyphenyl)ethylcarbonyloxy]ethyl]oxamide (manufactured by ADEKA CORPORATION), and THANOX MD697 (hereinafter, referred to as “MD697,” manufactured by Rianlon Corporation).

These components (G-2) may be used alone or in combination of two or more kinds thereof. When two or more kinds of the component (G-2) are used in combination, it is preferable to use a combination such as an amine-based antioxidant and a sulfur-based antioxidant or a sulfur-based antioxidant and another antioxidant, and thus it is possible to obtain more satisfactory antirust properties. As specific examples of such a combination, combination such as BT-LX and Zisnet F, TT-LX and Nocrac MB, Zisnet F and MD697, or Zisnet DB and MD697 is preferable.

The (G) antioxidant is blended preferably in 0.01 to 5% by mass and more preferably in 0.1 to 3% by mass with respect to 100% by mass of the total amount of the composition. When the component (G-1) is blended, oxidation of the composition that is the invention of the present application is prevented, and thus storage properties can be improved. Further, when the component (G-2) is blended, oxidation of the conductor of the covered wire or the terminal fitting is prevented, and thus corrosion resistance is improved. Therefore, satisfactory electrical conductivity can be maintained over a long period of time. In particular, even in a case where the conductor of the covered wire and the terminal fitting are formed by different metals, corrosion resistance can be effectively improved.

In the wire sealer, thermal curing can be concurrently used in addition to radiation curing. When thermal curing is concurrently used, (D) organic peroxide is preferably blended. The (D) organic peroxide is a radical polymerization initiator of thermosetting reaction, and specific examples thereof include cumene hydroperoxide, tertiary butyl peroxide, methyl aceto-acetate peroxide, methyl cyclohexane peroxide, diisopropyl peroxide, dicumyl peroxide, diisopropyl peroxy carbonate, benzoyl peroxide, and tertiary butyl peroxy neodecanoate. These may be used alone or in combination of two or more kinds thereof.

The (D) organic peroxide is blended preferably in 0.1 to 5% by mass and particularly preferably in 0.3 to 2% by mass, with respect to 100% by mass of the total amount of the wire sealer.

When the blended amount of the component (D) is within the above ranges, the thermosetting reaction performance is satisfactory, and thus the dark part curing performance is improved. Accordingly, effective sealing treatment can be performed.

When the component (D) is blended, a promotor for thermosetting reaction as a component (E) (hereinafter, referred to as the “polymerization promotor”) can also be further blended. The component (E) is a component for promoting the decomposition of the component (D) and promoting the thermosetting reaction together with the component (D). The component (E) is not particularly limited, and specific examples thereof may include thio urea derivatives such as diethyl thio urea, dibutyl thio urea, ethylene thio urea, tetramethyl thio urea, 2-mercaptobenzimidazole-based compound, and benzoyl thio urea, or salts thereof; amines such as N,N-diethyl-p-toluidine, N,N-dimethyl-p-toluidine, N,N-diisopropanol-p-toluidine, triethylamine, tripropylamine, ethyl diethanolamine, N,N-dimethyl aniline, ethylene diamine, and triethanolamine; metal salts of organic acids such as cobalt naphthenate, copper naphthenate, zinc naphthenate, cobalt octenate, and iron octylate; and organic metal chelate compounds such as copper acetyl acetonate, titanium acetyl acetonate, manganese acetyl acetonate, chromium acetyl acetonate, iron acetyl acetonate, vanadyl acetyl acetonate, and cobalt acetyl acetonate. These may be used alone or in combination of two or more kinds thereof.

The component (H) is a (meth)acrylate compound having an anion dissociative group. Herein, the anion dissociative group has the same meaning as the anion dissociative group in the component (B). When the component (H) is added, adhesiveness with respect to various substrates such as glass, aluminum, tin-plated brass, and copper can be improved.

Specific examples of the component (H) include a (meth)acrylate compound having a phosphoric acid group such as bis(methacryloxyethyl)phosphate (a compound represented by the following Formula (2)). Examples of the (meth)acrylate compound having a phosphoric acid group may include commercial products such as KAMMER PM-2 and PM-21 manufactured by Nippon Kayaku Co., Ltd.

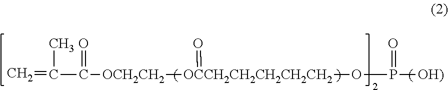

Further, other specific examples of the component (H) include a (meth)acrylate compound having a carboxyl group (a carboxy group) such as (meth)acrylic acid, ω-carboxy-polycaprolactone mono(meth)acrylate, or phthalic acid monohydroxyethyl (meth)acrylate. Examples of commercial products thereof may include ARONICS M-5300 and M-5400 (both manufactured by TOAGOSEI CO., LTD.).

The component (H) is blended preferably in 0.1 to 10% by mass and particularly preferably in 0.3 to 7% by mass with respect to 100% by mass of the total amount of the wire sealer. Further, when the component (A) is urethane (meth)acrylate having two ethylenically unsaturated groups, the component (H) is blended preferably in 0.1 to 4% by mass and particularly preferably in 0.3 to 3% by mass with respect to 100% by mass of the total amount of the wire sealer.

When the blended amount of the component (H) is within the above ranges, the thermosetting reaction performance is satisfactory, and thus the dark part curing performance is improved. Accordingly, effective sealing treatment can be performed.

Every viscosity of the wire sealer of the present invention at 25° C. is 0.5 to 100 mPa·s and preferably 1 to 30 mPa·s. When the viscosity is within the above range, the viscosity of the composition is suppressed to be low. Therefore, the wire sealer easily enters, by capillary phenomenon, into a gap between a conductor and a coating layer thereof or a gap between a conductor and a terminal fitting so that effective sealing treatment can be performed. Incidentally, the viscosity is a value obtained by measuring the viscosity at 25° C. by using a type B viscometer.

Regarding the radiation curing condition of the wire sealer of the present invention, the wire sealer is cured by irradiation of radiation having an energy density of 0.1 to 5 J/m² for about 1 second to 1 minute in air or in an inert gas environment such as nitrogen. The temperature at the time of curing is preferably 10 to 40° C., and in general, the curing can be performed at room temperature. Incidentally, herein, radiation includes, for example, infrared rays, visible rays, ultraviolet rays, X-rays, electron beams, α rays, β rays, and γ rays.

### 2. Sealing Member and Wire Obtained by Sealing Treatment:

The sealing member of the present invention is formed by a cured product obtained by curing the aforementioned wire sealer. The sealing member is typically used in permanent sealing treatment, and thus the sealing member is required to have enough properties to resist easy peeling-off by, for example, external physical force or temperature change, and exposure of a metal portion such as a conductor or a terminal fitting. For this reason, a balance between the strength of the sealing member (particularly, breaking strength) and the adhesive force with a conductor or a terminal fitting (adhesive force evaluated by 180° peel strength in examples) is important, and it is preferable to have a physical property that an interface between the sealing member and the metal portion is not easily to expose.

Specifically, in addition to the fact that it is preferable to have the aforementioned Young's modulus, the adhesive force between the sealing member and aluminum, copper or tin-plated copper is preferably set such that the sealing member is not peeled off when a torque of 1000 N/m is applied in a test for 180° peel strength (180° peeling strength) measured according to the method defined in JIS K 6854-2.

Incidentally, the shape of the sealing member is not particularly limited, and an arbitrary shape can be employed by a sealing treatment method to be described below.

### 3. Sealing Treatment Method for Wire:

The region for application of the sealing treatment in the wire is not particularly limited, and typically, the sealing treatment is performed on a conductor exposure portion in which the conductor is exposed when a plurality of wires are electrically connected, end portions of the wire, or an electric contact portion between a conductor and, for example, a terminal fitting.

The sealing treatment method of the present invention includes, in a case where the sealing treatment is performed on the conductor exposure portion in which a portion of a coating material of the covered wire is removed to expose the conductor or in a case where the sealing treatment is performed on the electric contact portion at which conductor exposure portions of a plurality of covered wires are electrically connected to each other, a sealing material adhering step of adhering the wire sealer to the conductor exposure portion or the electric contact portion and a sealing material curing step of irradiating a region, to which the wire sealer is adhered, of the wire with radiation. When the sealing treatment method of the present invention is used, it is possible to produce a covered wire subjected to sealing treatment.

The sealing material adhering step with respect to the wire is a step of adhering the wire sealer to the conductor exposure portion or the electric contact portion for application of the sealing treatment. The adhering method is not particularly limited, and the conductor exposure portion or the electric contact portion may be immersed in the wire sealer or the wire sealer may be applied to the conductor exposure portion or the electric contact portion. In addition, it is possible to add treatment in which the wire sealer is pulled into the gap between the conductor and the coating layer thereof from the conductor exposure portion by sucking from one end of the wire. Herein, the conductor exposure portion or the electric contact portion for application of the sealing treatment may be an end portion of each wire or may be an intermediate portion of the wire.

The sealing material curing step is a step of curing the wire sealer by irradiation of radiation on the region where the wire sealer is filled or has been filled. The specific curing condition is the same as described in the section of the sealing member.

Further, the sealing treatment method of the present invention includes, in a case where the sealing treatment is performed on the electric contact portion between the conductor exposure portion obtained by removing a portion of a coating material of the covered wire and, for example, the terminal fitting, a sealing material adhering step of adhering the wire sealer to the electric contact portion and a sealing material curing step of irradiating a region, to which the wire sealer is adhered, of the wire with radiation.

In this case, the sealing material adhering step with respect to the electric contact portion is a step of swaging the terminal fitting to the terminal of the wire to electrically connect the conductor of the wire and the terminal fitting, and then adhering the wire sealer to the surface of the contact portion between the conductor of the wire and the terminal fitting, that is, the electric contact portion formed by the surface of the insulator of the terminal, the surface of the exposed conductor of the wire, and the surface of the base end of the contact portion. At this time, when the terminal fitting has an insulation barrel or a wire barrel, the wire sealer is also preferably adhered to the surface of the insulation barrel or the wire barrel. Accordingly, a coating film of the wire sealer is formed on the surface of the contact portion between the conductor of the wire and the terminal fitting.

When the wire sealer is adhered, a method of, for example, dropwise addition or coating can be used. As necessary, heating or cooling may be performed. The sealing material curing step is the same as described above.

The wire sealer of the present invention is useful as a sealing material for a wire, particularly for a telephone cable or a wire for an automobile such as a wire harness. When the sealing treatment is performed using the wire sealer of the present invention according to the sealing treatment method, a sealing member which is uniform and is excellent in strength is formed, and thus effective sealing treatment can be performed. Further, the sealing member formed according to the present invention has an excellent strength and a high adhesiveness with respect to, for example, a conductor, a coating material, or a sheath, and thus effective sealing treatment can be performed. Moreover, the sealing member has an effective anti-corrosion effect also with respect to a laminate body made of dissimilar metals of aluminum used in the conductor of the covered wire and brass subjected to plating treatment with tin, which is used in the terminal fitting, (hereinafter, referred to as the “tin-plated brass”), and the sealing member is also useful as a wire sealer in the case of using a terminal fitting made of the different type of metal from that of the conductor of the covered wire.

### EXAMPLES

Next, the present invention will be described in detail by means of examples, but the present invention is not limited to these examples.

### Synthesis Example 1

### Synthesis 1 of (A) Urethane Acrylate

To a reaction container equipped with a stirrer, 0.013 g of 2,6-di-t-butyl-p-cresol, 5.36 g of 2,4-tolylene diisocyanate, and 44.4 g of acrylic isobornyl were added, and cooled to 15° C. while stirring. Thereto, 49.3 g of polytetramethylene glycol having a molecular weight of 2000 was added, and the resultant mixture was adjusted to room temperature and then reacted for 2 hours at 40° C. while 0.044 g of dilaurate dibutyl tin was added several times in a divided manner. Thereafter, 0.284 g of methanol was added dropwise thereto while paying attention such that the temperature did not increase to 50° C. or higher, and the resultant mixture was stirred for 1 hour. Then, 0.942 g of hydroxyethyl acrylate was slowly added dropwise thereto while controlling the temperature not to increase to 50° C. or higher, and the resultant mixture was stirred. After exotherm was confirmed, the resultant mixture was stirred for 3 hours at 65° C., and the reaction was terminated when the residual isocyanate was decreased to 0.1% by mass or less.

The obtained urethane acrylate is referred to as UA-1. The UA-1 has one acryloyl group and four (on average) structural units derived from PTMG.

### Synthesis Example 2

### Synthesis 2 of (A) Urethane Acrylate

To a reaction container equipped with a stirrer, 0.013 g of 2,6-di-t-butyl-p-cresol, 5.65 g of 2,4-tolylene diisocyanate, and 44.4 g of acrylic isobornyl were added and cooled to 15° C. Thereto, 48.7 g of polytetramethylene glycol having a number average molecular weight of 2000 was added, and after 0.044 g of dilaurate dibutyl tin was added thereto, the resultant mixture was adjusted to room temperature while stirring, and then reacted for 2 hours while 0.044 g of dilaurate dibutyl tin was added several times in a divided manner. Thereafter, 0.284 g of methanol was added dropwise thereto while controlling the temperature not to increase to 50° C. or higher, and the resultant mixture was stirred for 1 hour. Then, 0.942 g of hydroxyethyl acrylate was added dropwise thereto while controlling the liquid temperature not to increase to 50° C. or higher, and the resultant mixture was stirred for 1 hour at about 40° C. After exotherm was confirmed, the resultant mixture was stirred for 3 hours at 65° C., and the reaction was terminated when the residual isocyanate was decreased to 0.1% by mass or less.

The obtained urethane acrylate is referred to as UA-2. The UA-2 has one acryloyl group and three (on average) structural units derived from PTMG.

### Synthesis Example 3

### Synthesis 3 of (A) Urethane Acrylate

Urethane acrylate was synthesized in the same manner as in Synthesis Example 2, except that 48.7 g of polypropylene glycol having a number average molecular weight of 2000 was used instead of polytetramethylene glycol having a number average molecular weight of 2000.

The obtained urethane acrylate is referred to as UA-3. The UA-3 has one acryloyl group and three (on average) structural units derived from PPG.

### Synthesis Example 4

### Synthesis 4 of (A) Urethane Acrylate

Urethane acrylate was synthesized in the same manner as in Synthesis Example 2, except that 48.7 g of polycarbonate having a number average molecular weight of 2000 was used instead of polytetramethylene glycol having a number average molecular weight of 2000.

The obtained urethane acrylate is referred to as UA-4. The UA-4 has one acryloyl group and three (on average) structural units derived from polycarbonate.

### Synthesis Example 5

### Synthesis 5 of (A) Urethane Acrylate

To a reaction container equipped with a stirrer, 0.011 g of 2,6-di-t-butyl-p-cresol, 4.94 g of 2,4-tolylene diisocyanate, and 49.9 g of acrylic isobornyl were added and then cooled to 15° C. while stirring. Thereto, 39.8 g of polytetramethylene glycol having a number average molecular weight of 2000 was added, the resultant mixture was adjusted to room temperature, 0.037 g of dilaurate dibutyl tin was added several times in a divided manner thereto, and the resultant mixture was reacted for 2 hours. Thereafter, 0.297 g of methanol was added dropwise thereto and stirred for 1 hour. Thereafter, 0.984 g of hydroxyethyl acrylate was added dropwise thereto while controlling the liquid temperature to be 50° C. or lower, and the resultant mixture was stirred for 1 hour at about 40° C. After exotherm was confirmed, the resultant mixture was stirred for 3 hours at 65° C., and the reaction was terminated when the residual isocyanate was decreased to 0.1% by mass or less.

The obtained urethane acrylate is referred to as UA-5. The UA-5 has one acryloyl group and 2.3 (on average) structural units derived from PTMG.

### Synthesis Example 6

### Synthesis 6 of (A) Urethane Acrylate

To a reaction container equipped with a stirrer, 23.1 g of isobornyl acrylate, 0.018 g of 2,6-di-t-butyl-p-cresol, and 10.7 g of tolylenediisocyanate were added and cooled until the liquid temperature became 15° C. Thereto, 59.6 g of hydrogenated polyisoprene having a number average molecular weight of 2000 was added and cooled until the liquid temperature became 15° C. Thereafter, 0.061 g of dilaurate dibutyl tin was added, and the resultant mixture was stirred for about 1 hour while paying attention such that the temperature did not increase to 50° C. or higher. Thereafter, 1.08 g of methanol and 3.57 g of 2-hydroxypropyl acrylate were slowly added while controlling the liquid temperature not to exceed 40° C., and then the resultant mixture was stirred for about 1 hour. Further, stirring was continued for 2 hours at a liquid temperature of 70 to 75° C., and the reaction was terminated when the residual isocyanate was decreased to 0.1% by mass or less. The obtained urethane acrylate is referred to as UA-6. The UA-6 has one acryloyl group.

### Synthesis Example 7

### Synthesis 7 of (A) Urethane Acrylate

To a reaction container equipped with a stirrer, 0.013 g of 2,6-di-t-butyl-p-cresol, 5.311 g of 2,4-tolylene diisocyanate, and 44.4 g of acrylic isobornyl were added and then cooled to 15° C. while stirring. Thereto, 48.8 g of polytetramethylene glycol having a molecular weight of 2000 was added, and the resultant mixture was adjusted to room temperature and then reacted for 2 hours while 0.044 g of dilaurate dibutyl tin was added several times in a divided manner. Thereafter, 1.42 g of hydroxyethyl acrylate was added dropwise thereto while controlling the liquid temperature to be 40° C. or lower. Then, the resultant mixture was stirred for 1 hour at 40° C. in a hot water bath. After exotherm was confirmed, the resultant mixture was stirred for 3 hours at 65° C., and the reaction was terminated when the residual isocyanate was decreased to 0.1% by mass or less.

The obtained urethane acrylate is referred to as UA-7. The UA-7 has two acryloyl groups and four (on average) structural units derived from PTMG.

### Synthesis Example 8

### Synthesis 8 of (A) Urethane Acrylate

In a reaction container equipped with a stirrer, 23.1 g of isobornyl acrylate, 10.7 g of tolylenediisocyanate, 0.018 g of 2,6-di-t-butyl-p-cresol, and 0.061 g of dilaurate dibutyl tin were input, and cooled in ice until the liquid temperature became 15° C. or lower while stirring. Thereto, 59.6 g of ring-opening polymer of propylene oxide having a number average molecular weight of 2000 was added, and the resultant mixture was stirred for 2 hours to be reacted while controlling the liquid temperature to be 35° C. or lower. Next, 6.92 g of hydroxyethyl acrylate was added dropwise thereto and the resultant mixture was stirred for 3 hours at a liquid temperature of 70 to 75° C. Then, the reaction was terminated when the residual isocyanate was decreased to 0.1% by weight or less.

The obtained urethane acrylate is referred to as UA-8.

### Synthesis Example 9

### Synthesis 9 of (A) Urethane Acrylate

In a reaction container equipped with a stirrer, 2.53 g of 2,4-tolylene diisocyanate, 0.018 g of 2,6-di-t-butyl-p-cresol, 0.061 g of dilaurate dibutyl tin, and 0.008 g of phenothiazine were input, and cooled in ice until the liquid temperature became 15° C. or lower while stirring. Thereto, 72.6 g of ring-opening polymer of propylene oxide having a number average molecular weight of 10000 was added, and the resultant mixture was stirred for 1 to 2 hours at 50° C. Thereafter, 1.69 g of hydroxyethyl acrylate was added dropwise thereto while controlling the liquid temperature to be 50° C. or lower, and then stirring was continued for 3 hours at a liquid temperature of 70 to 75° C. The reaction was terminated when the residual isocyanate was decreased to 0.1% by weight or less.

The obtained urethane acrylate is referred to as UA-9.

### Synthesis Example 10

### Synthesis 10 of (A) Urethane Acrylate

To a reaction container equipped with a stirrer, 0.018 g of 2,6-di-t-butyl-p-cresol and 32.9 g of tolylenediisocyanate were added and the liquid temperature was adjusted to 15° C. Thereto, 0.061 g of dilaurate dibutyl tin was added, and 43.9 g of 2-hydroxyethyl acrylate was slowly added thereto while paying attention such that the temperature did not increase to 40° C. or higher and controlling the liquid temperature not to exceed 40° C., and then the resultant mixture was stirred for about 1 hour. Further, stirring was continued for 2 hours at a liquid temperature of 70 to 75° C., and the reaction was terminated when the residual isocyanate was decreased to 0.1% by mass or less.

The obtained urethane acrylate is referred to as UA-10.

### Synthesis Example 11

### Synthesis 11 of (A) Urethane Acrylate

To a reaction container equipped with a stirrer, 0.018 g of 2,6-di-t-butyl-p-cresol and 31.9 g of tolylenediisocyanate were added and the liquid temperature was adjusted to 15° C. Thereto, 0.061 g of dilaurate dibutyl tin was added, 23.8 g of 2-hydroxypropyl acrylate was added while paying attention such that the temperature did not increase to 40° C. or higher, and subsequently, 21.2 g of 2-hydroxyethyl acrylate was slowly added while controlling the liquid temperature not to exceed 40° C., and then the resultant mixture was stirred for about 1 hour. Further, stirring was continued for 2 hours at a liquid temperature of 70 to 75° C., and the reaction was terminated when the residual isocyanate was decreased to 0.1% by mass or less.

The obtained urethane acrylate is referred to as UA-11.

### Comparative Synthesis Example 1

### Synthesis 1 of Urethane Compound:

To a reaction container equipped with a stirrer, 0.013 g of 2,6-di-t-butyl-p-cresol, 5.41 g of 2,4-tolylene diisocyanate, and 44.4 g of acrylic isobornyl were added and then cooled to 15° C. while stirring. Thereto, 49.7 g of polytetramethylene glycol having a molecular weight of 2000 was added, and the resultant mixture was adjusted to room temperature and then reacted for 2 hours while 0.044 g of dilaurate dibutyl tin was added several times in a divided manner. Thereafter, 0.435 g of methanol was added dropwise thereto while controlling the liquid temperature to be 50° C. or lower. Then, the resultant mixture was stirred for 1 hour at about 40° C. in a hot water bath. After exotherm was confirmed, the resultant mixture was stirred for 3 hours at 65° C., and the reaction was terminated when the residual isocyanate was decreased to 0.1% by mass or less.

The obtained urethane compound is referred to as UA'-1. The UA'-1 has four (on average) structural units derived from PTMG but does not have an acryloyl group.

### Examples 1 to 16 and Comparative Examples 1 to 4

Each of components having compositions presented in Table 1 and Table 2 was input in a reaction container equipped with a stirrer, and stirred for 1 hour while controlling the liquid temperature to be 50° C., thereby a liquid curable resin composition as a wire sealer.

The liquid curable resin compositions obtained in Examples and Comparative Examples were cured by the method as described below to prepare test pieces, and each of the following evaluations was performed. The results thereof are presented in Table 1 and Table 2.

### [Evaluation Method]

### 1. Viscosity:

The viscosity at 25° C. of each of the compositions obtained in Examples and Comparative Examples was measured by using a type B viscometer.

### 2. Young's Modulus:

A film for measuring a Young's modulus was obtained in such a manner that a liquid curable resin composition was applied onto a glass plate using an applicator bar capable of performing application to have a thickness of 200 μm and the liquid curable resin composition was cured by irradiation of an ultraviolet ray of an energy of 1 J/cm² when the ultraviolet ray having an energy intensity of 200 mJ/cm²/s was radiated for 5 seconds in nitrogen. A strip sample was prepared from this film so as to have an extended portion having a width of 6 mm and a length of 25 mm, and a tensile test was performed at a temperature of 23° C. and a humidity of 50%. The Young's modulus was obtained from a tensile strength at a tension rate of 1 mm/min and a distortion of 2.5%.

### 3. Breaking Strength and Breaking Elongation:

A measurement film was prepared in the same manner as in the case of measuring the Young's modulus, and the breaking strength and the breaking elongation of a test piece were measured under the following measurement conditions by using a tensile tester (AGS-50G manufactured by Shimadzu Corporation).
Tension rate: 50 mm/min
Inter-marker distance (measurement distance): 25 mm
Measurement temperature: 23° C.
Relative humidity: 50% RH

### 4. 180° Peel Strength:

A resin film was formed on each substrate of a glass plate, an aluminum plate, a tin-plated brass plate, and a copper plate by applying a resin having a thickness of 200 μm and curing the resin in the same manner as in the case of measuring the Young's modulus, a test for 180° peel strength (180° peeling strength) was performed according to the method defined in JIS K 6854-2, and then existence of peeling-off was evaluated when a torque of 3000 N/m was applied. The types of peeling-off when evaluation was carried out at a torque of 3000 N/m were evaluated by dividing the types into a case where the resin film was broken and a case where the resin film was peeled off from the interface between the resin film and the substrate.

A case where the resin film was not peeled off from the substrate at all and the resin film was broken was determined as “not peeling-off,” a case where a part of the resin film was peeled off from the substrate and the resin film was broken was determined as “partially peeling-off,” and a case where the resin film was peeled off from the substrate without the resin film being broken was determined as “peeling-off”.

Further, existence of peeling-off was evaluated in the same manner as in the above-described method, except that a torque was changed to 1000 N/m. Regardless of whether the type of the peeling-off was the breakage of the resin film or the peeling-off from the substrate, a case where there was no peeling-off was determined as passing “A”, and a case where there was peeling-off was determined as failing “B”.

### 5. Corrosion Resistance Evaluation:

A liquid curable resin composition was applied, with an applicator bar capable of performing application to have a thickness of 20 μm, onto a copper plate having a thickness of 1 mm or a part of a laminate plate of a tin-plated brass plate having a thickness of 1 mm and an aluminum plate having a thickness of 1 mm (hereinafter, referred to as the “laminate plate of the tin-plated brass plate and the aluminum plate”) at the tin-plated brass plate side, this liquid curable resin composition was cured by irradiation of an ultraviolet ray of an energy of 1 J/cm² when the ultraviolet ray having an energy intensity of 200 mJ/cm²/s was radiated for 5 seconds in nitrogen, and an evaluation laminate body of the cured film and the copper plate or the laminate plate of the tin-plated brass plate and the aluminum plate. This evaluation laminate body was immersed in 5.0% by mass of saline solution, left to stand for one day at 35° C., and then taken out. Further, the evaluation laminate body was left to stand for 5 days in environment including a temperature of 85° C. and a relative humidity of 95%, and then the corrosion state of the copper plate or the laminate plate of the tin-plated brass plate and the aluminum plate was visually observed.

A case where the color tone of the copper plate or the laminate plate of the tin-plated brass plate and the aluminum plate at the end portion of the cured film was clearly changed due to the corrosion was evaluated as “B”, a case where the color tone was slightly changed was evaluated as “A”, and a case where the color tone was not substantially changed was evaluated as “AA”.

### 6. Oil Absorptivity:

A resin film was obtained in such a manner that a liquid curable resin composition was applied onto a polyethylene terephthalate plate using an applicator bar capable of performing application to have a thickness of 200 μm and the liquid curable resin composition was cured by irradiation of an ultraviolet ray of an energy of 1 J/cm² when the ultraviolet ray having an energy intensity of 200 mJ/cm²/s was radiated for 5 seconds (s) in air.

About 1 g of the resin film was cut and used as a film for measuring the oil absorptivity, and a mass W1 (g) thereof was weighed. The measurement film was immersed in transmission oil for automobiles (TOTAL transmission FR 75W90; manufactured by Total S.A.), oil adhering the surface was then wiped off with a non-woven fabric, and a mass W2 (g) of the measurement film was measured. The oil absorptivity was calculated by the following equation.

Oil absorptivity (% by mass)={(W2−W1)/W1}×100

The oil absorptivity was determined by using two cases of 7% by mass and 10% by mass as a standard. When 7% by mass was used as a standard, the case of 7% by mass or more was determined as passing “A,” and the case of less than 7% by mass was determined as failing “B.” When 10% by mass was used as a standard, the case of 10% by mass or more was determined as passing “A”, and the case of less than 10% by mass was determined as failing “B”.

### 7. Water Absorptivity:

A resin film was obtained by applying a resin having a thickness of 200 μm and curing the resin in the same manner as in the case of measuring the oil absorptivity. About 1 g of the resin film was cut and used as a film for measuring the water absorptivity. The measurement film was dried for 24 hours by a vacuum dryer of 50° C., the mass W1 (g) after drying was weighed. The dried film was immersed in distilled water, the film was left to stand for 24 hours in a thermo-hygrostat (23° C. and a relative humidity of 50%), the measurement film was taken out from the thermo-hygrostat, water droplets adhering the surface were wiped off with a non-woven fabric, the mass W2 (g) of the measurement film was measured. This film was dried again for 24 hours by the vacuum dryer of 50° C., a mass W3 (g) of the measurement film was measured. The water absorptivity was calculated by the following equation.

Water absorptivity (% by mass)={(W2−W3)/W1}×100

A case where the water absorptivity was 10% by mass or less was determined as passing “A”, and a case where the water absorptivity exceeded 10% by mass was determined as failing “B”.

TABLE 1

| | | Ex. 1 | Ex.2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| (A1) | UA-1 | 35 | 35 | | | | | 35 | 35 | | |
| | UA-2 | | | | 43 | | | | | | |
| | UA-3 | | | | | 43 | | | | | |
| | UA-4 | | | | | | 43 | | | | |
| | UA-5 | | | 48 | | | | | | 48 | 48 |
| | UA-6 | | | | | | | | | | |
| (A2) | UA-7 | | | | | | | | | | |
| | UA-8 | | | | | | | | | | |
| | UA-9 | | | | | | | | | | |
| | UA-10 | | | | | | | | | | |
| | UA-11 | | | | | | | | | | |
| (B) | Isobornyl | 48 | 48 | 52 | 52 | 52 | 52 | 48 | 48 | 52 | 52 |
| | acrylate | | | | | | | | | | |
| | Acryloyl | 2 | 2 | | | | | 2 | 2 | | |
| | morpholine | | | | | | | | | | |
| | 2-Hydroxy- | 15 | 15 | | 5 | 5 | 5 | 15 | 15 | | |
| | propyl acrylate | | | | | | | | | | |
| | N-Vinyl | | | | | | | | | | |
| | caprolactam | | | | | | | | | | |
| (F) | Trimethylol | | | | | | | | | | |
| | propane | | | | | | | | | | |
| | triacrylate | | | | | | | | | | |
| | Tripropylene | | | | | | | | | | |
| | glycol | | | | | | | | | | |
| | diacrylate | | | | | | | | | | |
| | Bisphenol A | | | | | | | | | | |
| | epoxy diacrylate | | | | | | | | | | |
| (C) | Irgacure184 | 2.0 | 2.0 | 2.0 | 2.0 | 2.0 | 2.0 | 2.0 | 2.0 | 2.0 | 2.0 |
| | Lucirin TPO | 0.9 | 0.9 | 0.9 | 0.9 | 0.9 | 0.9 | 0.9 | 0.9 | 0.9 | 0.9 |
| H | Bis(methacryloxy- | 5.0 | 0.5 | 0.5 | 0.5 | 2.0 | 0.5 | 5.0 | 0.5 | 0.5 | 0.5 |
| | ethyl) phosphate | | | | | | | | | | |
| (G) | G-2a | | | | | | | 0.5 | | | |
| | G-2b | | | | | | | | 0.5 | | |
| | G-2c | | | | | | | | | 0.5 | 0.5 |
| | G-2d | | | | | | | | | | 0.5 |
| Other | UA′-1 | | | | | | | | | | |
| | Total | 107.9 | 103.4 | 103.4 | 103.4 | 104.9 | 103.4 | 108.4 | 103.9 | 103.9 | 104.4 |
| Compo- | Viscosity | 5.6 | 5.5 | 7.1 | 6.7 | 2.1 | 5.8 | 5.6 | 5.5 | 7.1 | 7.1 |
| sition | (Pa · s) 25° C. | | | | | | | | | | |
| evalu- | | | | | | | | | | | |
| ation | | | | | | | | | | | |
| Cured | Young's modulus | 48 | 47 | 33 | 43 | 14 | 45 | 48 | 47 | 33 | 33 |
| film | (MPa) 23° C. | | | | | | | | | | |
| evalu- | Breaking strength | 4.2 | 4.5 | 6.9 | 6.1 | 1.9 | 5.1 | 4.2 | 4.5 | 6.9 | 6.9 |
| ation | (MPa) 23° C. | | | | | | | | | | |
| | Breaking elongation | 322 | 487 | 482 | 484 | 421 | 420 | 322 | 487 | 482 | 482 |
| | (%) 23° C. | | | | | | | | | | |
| | Breaking elongation | 205 | 232 | 252 | 240 | 220 | 210 | 205 | 232 | 252 | 252 |
| | (%) −40° C. | | | | | | | | | | |
| | 180° Peel strength | No | No | No | No | No | No | No | No | No | No |
| | (3000 N/m) | peeling- | peeling- | peeling- | peeling- | peeling- | peeling- | peeling- | peeling- | peeling- | peeling- |
| | Glass plate | off | off | off | off | off | off | off | off | off | off |
| | 180° Peel strength | No | Partial | Partial | Partial | Partial | Partial | No | Partial | Partial | Partial |
| | (3000 N/m) | peeling- | peeling- | peeling- | peeling- | peeling- | peeling- | peeling- | peeling- | peeling- | peeling- |
| | Aluminum plate | off | off | off | off | off | off | off | off | off | off |
| | 180° Peel strength | No | No | No | No | No | Partial | No | No | No | No |
| | (3000 N/m) Tin-plated | peeling- | peeling- | peeling- | peeling- | peeling- | peeling- | peeling- | peeling- | peeling- | peeling- |
| | brass plate | off | off | off | off | off | off | off | off | off | off |
| | 180° Peel strength | No | No | No | No | No | No | No | No | No | No |
| | (3000 N/m) | peeling- | peeling- | peeling- | peeling- | peeling- | peeling- | peeling- | peeling- | peeling- | peeling- |
| | Copper plate | off | off | off | off | off | off | off | off | off | off |
| | 180° Peel strength | A | A | A | A | A | A | A | A | A | A |
| | (1000 N/m) Glass plate | | | | | | | | | | |
| | 180° Peel strength | A | A | A | A | A | A | A | A | A | A |
| | (1000 N/m) | | | | | | | | | | |
| | Aluminum plate | | | | | | | | | | |
| | 180° Peel strength | A | A | A | A | A | A | A | A | A | A |
| | (1000 N/m) Tin-plated | | | | | | | | | | |
| | brass plate | | | | | | | | | | |
| | 180° Peel strength | A | A | A | A | A | A | A | A | A | A |
| | (1000 N/m) Copper plate | | | | | | | | | | |
| | Copper plate | A | A | A | A | A | A | AA | AA | AA | AA |
| | corrosion resistance | | | | | | | | | | |
| | evaluation | | | | | | | | | | |
| | Laminate plate of tin- | A | A | A | A | A | A | AA | AA | AA | AA |
| | plated brass plate and | | | | | | | | | | |
| | aluminum plate corrosion | | | | | | | | | | |
| | evaluation | | | | | | | | | | |
| | Oil absorptivity (% by | A | A | A | A | A | A | A | A | A | A |
| | mass) 7% by mass or | | | | | | | | | | |
| | more: “A” | | | | | | | | | | |
| | Oil absorptivity (% by | A | A | A | A | A | A | A | A | A | A |
| | mass) 10% by mass or | | | | | | | | | | |
| | more; “A” | | | | | | | | | | |
| | Water absorptivity | A | A | A | A | A | A | A | A | A | A |
| | (% by mass) | | | | | | | | | | |

TABLE 2

| | | | | | | | | Comp. | Comp. | Comp. | Comp. |
|---|---|---|---|---|---|---|---|---|---|---|---|
| | | Ex. 11 | Ex. 12 | Ex. 13 | Ex. 14 | Ex. 15 | Ex. 16 | Ex. 1 | Ex. 2 | Ex. 3 | Ex. 4 |
| (A1) | UA-1 | | | | | | 20 | | | | |
| | UA-2 | 43 | | | | | | | 10 | | |
| | UA-3 | | | | | | | | | | |
| | UA-4 | | | | | | | | | | |
| | UA-5 | | | | | | | | | 26 | |
| | UA-6 | | | 43 | | | | | | | |
| (A2) | UA-7 | | 40 | | 35 | 35 | 23 | | | 44 | |
| | UA-8 | | | | | | | | | | 24 |
| | UA-9 | | | | | | | | | | 1 |
| | UA-10 | | | | | | | | | | 17 |
| | UA-11 | | | | | | | | | | 14 |
| (B) | Isobornyl acrylate | 52 | 55 | 52 | 48 | 48 | 48 | 48 | | 4.6 | 5.3 |
| | Acryloyl morpholine | | | | 2 | 2 | 2 | 2 | 20 | | |
| | 2-Hydroxypropyl | 5 | 5 | 5 | 15 | 15 | 15 | 15 | 70 | 12.8 | |
| | acrylate | | | | | | | | | | |
| | N-Vinyl caprolactam | | | | | | | | | 8.5 | |
| (F) | Trimethylol | | | | | | | | | 0.4 | |
| | propane triacrylate | | | | | | | | | | |
| | Tripropylene | | | | | | | | | | 25 |
| | glycol diacrylate | | | | | | | | | | |
| | Bisphenol A | | | | | | | | | | 14 |
| | epoxy diacrylate | | | | | | | | | | |
| (C) | Irgacure184 | 2.0 | 2.0 | 2.0 | 2.0 | 2.0 | 2.0 | 2.0 | 2.0 | 0.5 | 0.5 |
| | Lucirin TPO | 0.9 | 0.9 | 0.9 | 0.9 | 0.9 | 0.9 | 0.9 | 0.9 | 1.5 | 0.7 |
| (H) | Bis(methacryloxyethyl) | | | 0.5 | 5.0 | 3.0 | 0.5 | 5.0 | 5.0 | | |
| | phosphate | | | | | | | | | | |
| (G) | G-2a | | | | 0.5 | | | | | | |
| | G-2b | | | | | | | | | | |
| | G-2c | | | | | | | | | | |
| | G-2d | | | | | | | | | | |
| Other | UA′-1 | | | | | | | 35 | | | |
| Total | | 102.9 | 102.9 | 103.4 | 108.4 | 105.9 | 111.4 | 72.9 | 107.9 | 98.3 | 101.5 |
| Composition | Viscosity | 6.7 | 5.9 | 10.2 | 5.9 | 5.9 | 7.1 | | 1.2 | 7.8 | 2.7 |
| evaluation | (Pa · s) 25° C. | | | | | | | | | | |
| Cured film | Young's modulus | 43 | 19 | 48 | 23 | 23 | 40 | N.D. | 3.0 | 1.1 | 820 |
| evaluation | (MPa) 23° C. | | | | | | | | | | |
| | Breaking strength | 6.1 | 20.0 | 8.2 | 21 | 21 | 2.5 | N.D. | 2.1 | 1.7 | 39 |
| | (MPa) 23° C. | | | | | | | | | | |
| | Breaking elongation | 484 | 340 | 350 | 371 | 371 | 370 | N.D. | 220 | 173 | 39 |
| | (%) 23° C. | | | | | | | | | | |
| | Breaking elongation | 240 | 210 | 200 | 240 | 240 | 220 | N.D. | 120 | 100 | 2 |
| | (%) −40° C. | | | | | | | | | | |
| | 180° Peel strength | No | No | No | Peeling- | Peeling- | No | N.D. | Peeling- | Peeling- | Peeling- |
| | (3000 N/m) | peeling- | peeling- | peeling- | off | off | peeling- | | off | off | off |
| | Glass plate | off | off | off | | | off | | | | |
| | 180° Peel strength | Partial | Partial | Partial | Peeling- | Peeling- | Partial | N.D. | Peeling- | Peeling- | Peeling- |
| | (3000 N/m) | peeling- | peeling- | peeling- | off | off | peeling- | | off | off | off |
| | Aluminum plate | off | off | off | | | off | | | | |
| | 180° Peel strength | No | No | No | Peeling- | Peeling- | No | N.D. | Peeling- | Peeling- | Peeling- |
| | (3000 N/m) | peeling- | peeling- | peeling- | off | off | peeling- | | off | off | off |
| | Tin-plated brass plate | off | off | off | | | off | | | | |
| | 180° Peel strength | No | No | No | Peeling- | Peeling- | No | N.D. | Peeling- | Peeling- | Peeling- |
| | (3000 N/m) | peeling- | peeling- | peeling- | off | off | peeling- | | off | off | off |
| | Copper plate | off | off | off | | | off | | | | |
| | 180° Peel strength | A | A | A | A | A | A | N.D. | B | B | B |
| | (1000 N/m) | | | | | | | | | | |
| | Glass plate | | | | | | | | | | |
| | 180° Peel strength | A | A | A | A | A | A | N.D. | B | B | B |
| | (1000 N/m) | | | | | | | | | | |
| | Aluminum plate | | | | | | | | | | |
| | 180° Peel strength | A | A | A | A | A | A | N.D. | B | B | B |
| | (1000 N/m) | | | | | | | | | | |
| | Tin-plated brass plate | | | | | | | | | | |
| | 180° Peel strength | A | A | A | A | A | A | N.D. | B | B | B |
| | (1000 N/m) | | | | | | | | | | |
| | Copper plate | | | | | | | | | | |
| | Copper plate | A | A | A | A | A | A | N.D. | B | B | B |
| | corrosion resistance | | | | | | | | | | |
| | evaluation | | | | | | | | | | |
| | Laminate plate of | A | A | A | A | A | A | N.D. | B | B | B |
| | tin-plated brass | | | | | | | | | | |
| | plate and aluminum plate | | | | | | | | | | |
| | corrosion evaluation | | | | | | | | | | |
| | Oil absorptivity | A | A | A | A | A | A | N.D. | B | B | B |
| | (% by mass) | | | | | | | | | | |
| | 7% by mass or more: “A” | | | | | | | | | | |
| | Oil absorptivity | A | A | A | A | A | A | N.D. | B | B | B |
| | (% by mass) | | | | | | | | | | |
| | 10% by mass or more: “A” | | | | | | | | | | |
| | Water absorptivity | A | A | A | A | A | A | N.D. | B | B | A |
| | (% by mass) | | | | | | | | | | |

In Table 1 and Table 2,

Isobornyl acrylate; manufactured by Osaka Organic Chemical Industry Ltd., IBXA

acryloyl morpholine; manufactured by KOHJIN Film & Chemicals Co., Ltd., ACMO

2-hydroxypropyl acrylate; manufactured by Osaka Organic Chemical Industry Ltd., HPA

Irgacure184; manufactured by Ciba Specialty Chemicals Inc., 1-hydroxy cyclohexyl phenyl ketone

Lucirin TPO; manufactured by BASF Japan, 2,4,6-trimethyl benzoyl diphenyl phosphine oxide

Bis(methacryloxyethyl)phosphate; manufactured by Nippon Kayaku Co., Ltd., KAYAMER PM-2 (a compound represented by the above Formula (2))

G-2a; (1-[N,N-bis(2-ethylhexyl)aminomethyl]benzotriazole (BT-LX, manufactured by Johoku Chemical Co., Ltd.)

G-2b; N,N′-bis[3-(3,5-di-t-butyl-4-hydroxyphenyl)propionyl]hydrazine

G-2c; 2,4,6-trimercapto-s-triazine (Zisnet F, manufactured by Sankyo Kasei Co., Ltd.)

G-2d; N,N′-bis[2-[2-(3,5-di-tert-butyl-4-hydroxyphenyl)ethylcarbonyloxy]ethyl]oxamide (THANOX MD697, manufactured by Rianlon Corporation)

As presented in Table 1 and Table 2, each Example had an appropriate viscosity as the wire sealer, and had appropriate water absorptivity, oil absorptivity, Young's modulus, breaking strength, and breaking elongation as the sealing member. Regarding the 180° peel strength, when a torque of 1000 N/m was applied, the sealing member was not peeled off.

On the other hand, in Comparative Example 1, since the cured film was fragile, the Young's modulus, the breaking strength, the breaking elongation, the 180° peel strength, and the corrosion resistance could not be measured.

Further, Comparative Examples 2, 3, and 4 all are a composition containing components (A), (B), and (C). However, at least some values of the oil absorptivity, the water absorptivity, and the Young's modulus are out of the range of claim 1. For this reason, Comparative Examples 2, 3, and 4 had poor breaking elongation (23° C. and −40° C.) and poor substrate adhesiveness (180° peel strength) and were not suitable for the wire sealer. Among these Comparative Examples, Comparative Example 3 is a coating material typically used for a primary coating layer of the optical fiber, and Comparative Example 4 is a coating material typically used for a secondary coating layer of the optical fiber. For the primary coating layer of the optical fiber, a composition, which provides a cured product having a low crosslinking density and an extremely low Young's modulus, is typically used, and thus the sealing layer is easily broken in the 180° peeling test. On the other hand, for the secondary coating layer of the optical fiber, a composition, which provides a cured product having a high crosslinking density and an extremely high Young's modulus, is typically used. Therefore, the composition did not have an appropriate Young's modulus as the wire sealer, and thus 180° peel strength was poor. Regarding at least a part of the components (A), (B), and (C) necessary for the present invention, Comparative Examples 2, 3, and 4 were not included in the preferable blended amount range thereof.

1. A radiation-curable wire sealer, comprising:
(A) a urethane (meth)acrylate;
(B) a compound having one ethylenically unsaturated group and not having an anion dissociative group; and
(C) a radiation polymerization initiator;
wherein
a cured film obtained from the radiation-curable wire sealer shows an oil absorptivity of 7% by mass or more, a water absorptivity of 10% by mass or less, and a Young's modulus of 2 to 500 MPa; wherein
the cured film used for measuring the oil absorptivity and the water absorptivity is obtained via the below steps:
applying the radiation-curable wire sealer onto a polyethylene terephthalate plate with using an applicator bar capable of performing application to have a thickness of 200 μm, and
irradiating the radiation-curable wire sealer with an ultraviolet ray having an energy intensity of 200 mJ/cm²/s for 5 s in air; wherein
the oil absorptivity is a value obtained via the below steps:
cutting about 1 g of the cured film for use as a film for measuring the oil absorptivity,
weighing a mass W1 (g) of the film,
immersing the film in transmission oil for automobiles,
wiping the oil adhered to the surface of the film off using a non-woven fabric,
weighing a mass W2 (g) of the film, and
calculating the oil absorptivity according to the below equation:
Oil absorptivity (% by mass)={(W2−W1)/W1}×100;
the water absorptivity is a value obtained via the below steps:
cutting about 1 g of the cured film for use as a film for measuring the water absorptivity,
drying the film for 24 hours by a vacuum dryer of 50° C.,
weighing the mass W1 (g) after drying,
immersing the film in distilled water,
leaving the film to stand for 24 hours in a thermo-hygrostat (23° C. and a relative humidity of 50%),
removing the film from the thermo-hygrostat, and wiping water droplets adhered to the surface of the film off using a non-woven fabric,
weighing the mass W2 (g) of the film,
drying the film again for 24 hours by the vacuum dryer of 50° C.,
weighing a mass W3 (g) of the film, and
calculating the water absorptivity according to the below equation:
Water absorptivity (% by mass)={(W2−W3)/W1}×100;
the cured film for measuring the Young's modulus is obtained via the below steps:
applying the radiation-curable wire sealer onto a glass plate with an applicator bar capable of performing application to have a thickness of 200 μm, and
irradiating the radiation-curable wire sealer with an ultraviolet ray having an energy intensity of 200 mJ/cm²/s for 5 s in nitrogen atmosphere; and
the Young's modulus is a value obtained via the below steps:
preparing a strip sample having an extended portion having a width of 6 mm and a length of 25 mm, from the cured film, and
performing tensile test at a temperature of 23° C. and a humidity of 50%, and measuring a tensile strength at a tension rate of 1 mm/min and a distortion of 2.5%.

2. The radiation-curable wire sealer according to claim 1, wherein the component (A) is an urethane (meth)acrylate comprising at least one structural unit derived from at least one diol selected from the group consisting of a polyether diol, a polyester diol and a polycarbonate diol, each having an aliphatic structure, and one (meth)acryloyl group.

3. The radiation-curable wire sealer according to claim 1, comprising the following components (A) to (C) in the whole wire sealer as 100% by mass:
5 to 60% by mass of the component (A);
30 to 90% by mass of the component (B); and
0.01 to 10% by mass of the component (C).

4. The wire sealer according to claim 1, wherein a number average molecular weight of the component (A) is 8000 to 20000.

5. The wire sealer according to claim 2, wherein the component (A) comprises two to six structural units derived from the at least one diol.

6. The wire sealer according to claim 1, wherein the component (A) is a reaction product of
at least one dial selected from the group consisting of a polyether diol, a polyester diol and a polycarbonate diol each having an aliphatic structure,
a diisocyanate,
a hydroxyl group-containing (meth)acrylate, and
a monoalcohol.

7. The radiation-curable wire sealer according to claim 1, comprising 0 to 3% by mass of a phosphoric acid (meth)acrylate with respect to 100% by mass of the total amount of the wire sealer, wherein the component (A) is a urethane (meth)acrylate having two (meth)acryloyl groups.

8. The wire sealer according to claim 1, wherein 50 to 100% by mass of the total amount of the component (B) is
a compound having a cyclic structure and one ethylenically unsaturated group,
a compound having one ethylenically unsaturated group and an aliphatic hydrocarbon structure with 3 to 10 carbon atoms having a branched structure, or
a compound having a hydroxyl group and one ethylenically unsaturated group.

9. The wire sealer according to claim 1, which is adapted to function as a sealer for performing sealing treatment on a conductor exposure portion, wherein the conductor is exposed by removing a portion of a coating material of a covered wire.

10. The wire sealer according to claim 1, which is adapted to function as a sealer for performing sealing treatment on an electric contact portion, at which conductor exposure portions of a plurality of covered wires are electrically connected to each other.

11. The wire sealer according to claim 1, which is adapted to function as a sealer for performing sealing treatment on an electric contact portion, at which a conductor exposure portion of a covered wire and a terminal fitting are electrically connected to each other.

12. A radiation-curable wire sealer, comprising:
(A) 5 to 60% by mass of a urethane (meth)acrylate comprising at least one structural unit derived from at least one diol selected from the group consisting of a polyether diol, a polyester diol and a polycarbonate diol, each having an aliphatic structure, and one (meth)acryloyl group;
(B) 30 to 90% by mass of a compound having one ethylenically unsaturated group and not having an anion dissociative group; and
(C) 0.01 to 10% by mass of a radiation polymerization initiator, relative to 100% by mass of the wire sealer.

13. A sealing member obtained by curing the radiation-curable wire sealer according to claim 1.

14. A method for sealing treatment of a covered wire, the method comprising:
adhering the radiation-curable wire sealer according to claim 1 to a conductor exposure portion or an electric contact portion of a covered wire; and
irradiating a region in the covered wire to which the wire sealer is adhered.

15. A method for producing a sealed covered wire, the method comprising:
adhering the radiation-curable wire sealer according to claim 1 to a conductor exposure portion or an electric contact portion of a covered wire; and
irradiating a region in the covered with to which the wire sealer is adhered.
